(19) United States
(12) Patent Application Publication
(10) Pub. No.: US 2015/0042883 A1
(43) Pub. Date: Feb. 12, 2015

(54) Transparent FIPEL pixel panels displaying a normal image from the front surface and a reverse image from the back surface

(71) Applicant: Vizio Inc, Irvine, CA (US)

(72) Inventor: Matthew McRae, Irvine, CA (US)

(21) Appl. No.: 13/910,456

(22) Filed: Aug. 6, 2013

(51) Int. Cl. H04N 5/57; H04N 5/645

(52) U.S. Cl. CPC H04N 5/57; H04N 5/645
USPC 348/687

(57) ABSTRACT

A television formed of a FIPEL panel that creates light in both front and rear directions. An emissive layer is used, where the layer emits colored pixels of light. The pixels are emitted in both front direction, to be viewed by a tv viewer, and in the rear direction as a backlight. The emitted light can also illuminate the bezel of the television.

### BACKGROUND

FIPEL based backlight and image emitting pixel panels are relatively new concepts with regard to display panels for use in video monitors and televisions. The use of FIPEL devices is described in our copending applications, including Ser. No. 13/789,392 filed Mar. 7, 2013

FIPEL panels lend themselves to a variety of configurations ranging from backlight panels that can perform color balancing of the backlight to true transparent displays that can show passive images located behind the back surface of the panel to panels that display a normal image on the front surface to a reverse image on the back surface to panels that can display normal images from both the front and back surfaces of the panel.

This contrasts sharply with normal display panels using a light modulator assembly such as a LCD panel requiring a diffusor, two polarizers and a color filter.

### SUMMARY

Embodiments use a light emitting device referred to as FIPEL, or Field-Induced Polymer Electro-Luminescent device.

Embodiments describe providing light from the front surface through a color filter to a light modulator such as a LCD panel. A non-modulated light, e.g., a white light, is emitted from the back surface which may be diffused through a diffusor attached or bonded to the back surface of the FIPEL panel or a color filter attached or bonded to the back surface of the FIPEL panel. The diffusor may be a frosted sheet more commonly found in front of typical LED backlight assemblies or it may include microstructures designed to steer or defuse light.

LCD and Plasma monitors and televisions are well known in the art and have provided excellent products for many years. These types of monitors and televisions however are limited in their functionality for anything other than presenting images in a single direction and do not allow themselves to be used in new and imaginative ways.

What is needed is a new type of monitor/television that allows them to be used in new product and in new ways such as displaying images on both sides of the device or be transparent when images are not being displayed.

### BRIEF DESCRIPTION OF THE DRAWINGS

in the drawings:

FIG. 1 is a depiction of an asymmetrical (single dielectric layer) FIPEL device that emits light from one surface.

FIG. 2 is a depiction of an asymmetrical (single dielectric layer) FIPEL device that emits light from two surfaces.

FIG. 3 is a depiction of a symmetrical (two dielectric layers) FIPEL device that emits light from one surface.

FIG. 4 is a depiction of a symmetrical (two dielectric layers) FIPEL device that emits light from two surfaces.

FIG. 5 is a depiction of the CIE color index with a triangle bounding the colors that are specified by the NTSC standard for television.

FIG. 6 is a depiction of a FIPEL panel showing a pixel based panel with sub-pixels and control functions.

FIG. 7 is a depiction of a FIPEL panel based on individual pixels with no color filters.

FIG. 8 is a depiction of a FIPEL panel edge view where the panel emits light from both surfaces.

FIG. 9 is an edge view depiction of a bi-directional FIPEL panel showing the pixels in edge view, front view and exploded front view

FIGS. 10A and 10B are edge views of bi-directional stacked FIPEL panels that doubles the amount of light that can be emitted in both directions.

FIGS. 11A and 11B depict micro-lens/prisms/diffusors (11A) and light guides (11B) panel.

FIGS. 12A, 12B, 13A and 13B show an embodiment where the television becomes transparent when off;

FIGS. 14A, 14B and 14C show the transparent when off embodiment used on a windshield of an automobile;

FIG. 15 shows an operation of an embodiment used on a windshield.

### DETAILED DESCRIPTION

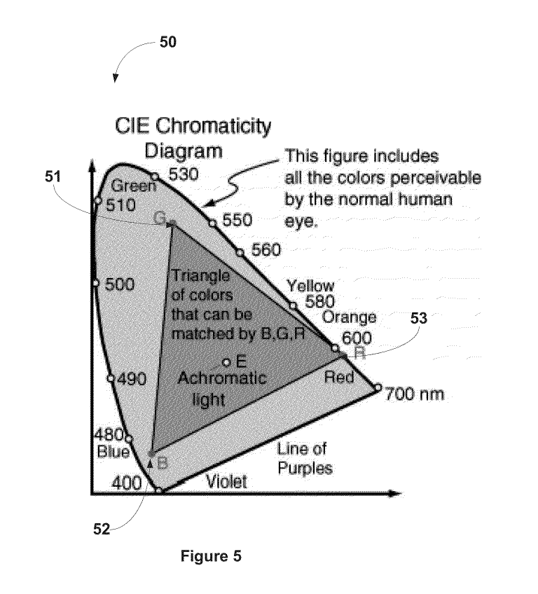

Embodiments use a lighting technology called Field Induced Polymer ElectroLumuinescence, referred to as FIPEL lighting. FIG. 5, CIE color chart, is taken from a website located at:

(http://hyperphysics.phy-str.gsu.edu%E2%80%8Chbase/vision/cie.html)

FIG. 5 is a replication of the CIE color index chart. Note that 51, 52 and 53 are points to the vertices Green (51), Blue (52) and Red (53). The three X,Y coordinates for a triangle that is the color space used for NTSC defined color.

A FIPEL backlight panel is able to emit any color on the CIE color chart. The panels described in the embodiments can emit color balanced white light in two directions or colored light in two directions. This allows FIPEL pixel based panels to display images in two directions.

In a preferred embodiment of the present invention, a monitor/television display may be used to cover some static image such as a painting. When the monitor/television is active, video content or material may be displayed on the front of the monitor/television. When the monitor/television is not active or turned off, the display will become transparent and the image behind the display can be seen.

In a slightly different embodiment, the monitor/television may be part of a window assembly. When the monitor/television is active, video content or material may be displayed on the front of the monitor/television. When the monitor/television is not active or turned off, the display becomes transparent and light and images on the other side of the window can be seen.

In another embodiment, the FIPEL panel/pixel array may be a display in a vehicle. When active, a rear view camera may send images to the display such that a driver can see what is behind her vehicle and when the panel is not active the display is transparent such that the driver can see through the display.

In another embodiment, a transparent FIPEL display may be a “Heads UP Display” for a vehicle where the FIPEL panel is in the same plane as the driver's eyes. When the display is active the data on the display will appear to be floating in front of the drive and when off the display will be transparent.

In another embodiment micro-structures may be attached to the front and/or rear surfaces of the display panel/pixel array. In this embodiment, the micro-structures may direct or diffuse the light being emitted by the panel.

In another environment, the display may be placed over another object such as another display where the rear display is only visible when the front display is not active and not visible when the front display is active.

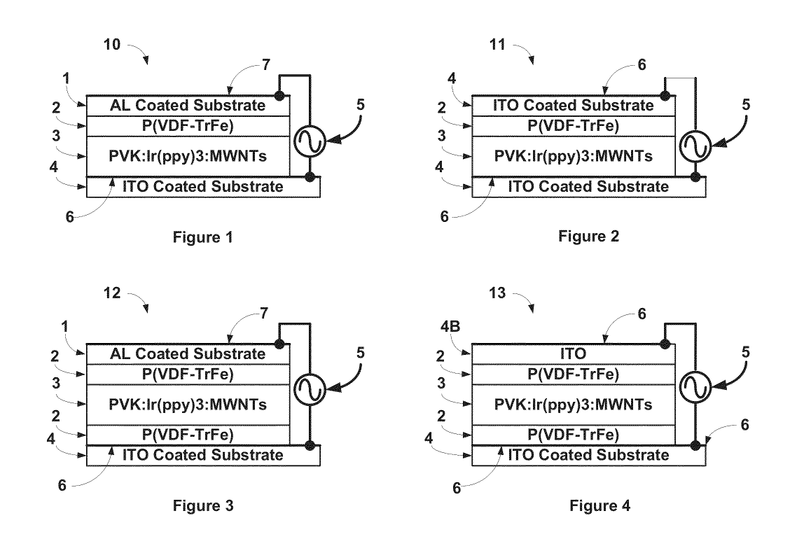

An embodiment uses FIPEL devices to carry out these functions. To appreciate the simplicity of FIPEL devices, reference FIGS. 1 and 2.

FIGS. 1 and 2 illustrate single dielectric FIPEL devices. The basic construction of these FIPEL devices is discussed in the following.

Lab quality FIPEL devices are generally fabricated on glass or suitable plastic substrates with various coatings such as aluminum and Indium tin oxide (ITO). ITO is a widely used transparent conducting oxide because of its two chief properties, it is electrical conductive and optical transparent, as well as the ease with which it can be deposited as a thin film onto substrates. Because of this, ITO is used for conducting traces on the substrates of most LCD display screens. As with all transparent conducting films, a compromise must be made between conductivity and transparency, since increasing the thickness increases the concentration of charge carriers which in turn increases the material's conductivity, but decreases its transparency. The ITO coating used for the lab devices discussed here is approximately 100 nm in thickness. In FIG. 1, emissive side substrate 4 is coated with ITO coating 6 residing against PVK layer 3. In FIG. 2, ITO coating 6 is on both substrates as shown.

Substrate 1 in FIGS. 1 and 3 is coated with an aluminum (AL) coating 7. The resulting thickness of the AL deposition is sufficient to be optically opaque and reflective. This ensures that any light from emissive layer 3 that travels toward substrate 1 is reflected and directed back through emissive substrate 4 with ITO coating 6 for devices illustrated in FIG. 1. If it is desired that light be emitted through both substrates, a substrate 4 with an ITO coating 6 will be substituted for substrate 1 with AL coating 7 as shown in FIG. 2.

The differences between the two similar substrates is how ITO coating 6 is positioned. In FIG. 1, emissive ITO coating 6 is positioned such that ITO coating 6 on substrate 4 is physically in contact with PVK layer 3. In FIG. 2, substrate 1 with Al coating 7 (FIG. 1) is replaced with substrate 4 with ITO coating 6 not in physical contact with the P(VDF-TrFe) (dielectric layer) layer 2. This allows light to be emitted from both the top and bottom surfaces of the FIPEL device.

Dielectric layer 2 in all cases is composed of a copolymer of P(VDF-TrFE) (51/49%). The dielectric layer is generally spin coated against the non-AL coated 7 side of substrate 1 or non-ITO coated 6 of substrate 4 of the top layer (insulated side). In all cases the dielectric layer is approximately 1,200 nm thick.

Emissive layer 3 is composed of a mix polymer base of poly (N-vinylcarbazole):fac-tris(2-phenylpyri-dine)iridium(III) [PVK:Ir(ppy)3] with Multi-Walled Nano Tubes (MWNT). The emissive layer coating is laid onto the dielectric layer to a depth of approximately 200 nm. For the lab devices with the greatest light output the concentration of MWNTs to the polymer mix is approximately 0.04% by weight.

When an alternating current is applied across the devices shown in FIGS. 1 and 2 (asymmetrical devices containing 1 dielectric layer) the emissive layer emits light at specific wavelengths depending on the frequency of the alternating current. The alternating current is applied across the conductive side of the top substrate 1 (Al coating 7) or substrate 4 and the conductive side (ITO coating 6) of bottom substrate 4. Light emission comes from the injection of electrons and holes into the emissive layer. Holes follow the PVK paths in the mixed emissive polymer and electrons follow the MWNTs paths.

Carriers within the emissive layer then recombine to form excitons, which are a bound state of an electron and hole that are attracted to each other by the electrostatic force or field in the PVK host polymer, and are subsequently transferred to the Ir(ppy)3 guest, leading to the light emission.

The frequency of the alternating current applied across the substrates of the FIPEL panel can also determine the color of light emitted by the panel. Any index on the CIE chart can be duplicated by selecting the frequency of the alternating current. Signal generator 5 may be of a fixed frequency which is set by electronic components or signal generator 5 may be controlled by a microprocessor executing algorithms that determine the frequency of signal generator 5 based on stimuli.

Aluminum coating 7 may also be any reflective and conductive coating such as but not limited to tin, nickel or other conductive and reflective coatings.

ITO coating 6 may be any conductive and transparent material such as, but not limited to graphene or ITO.

Now referencing FIG. 5 where a chart of the CIE color space is shown. Note that the lighter shaded area in the chart represents all of the colors that are perceived by the human eye. Various points on the edge of the lighter shaded envelope are identified by the wave length of light. The darker shaded triangle contains the colors that are in the NTSC color space. These can be reproduced by varying the amount of light in the red, blue and green areas controllable by graphic controllers in a television.

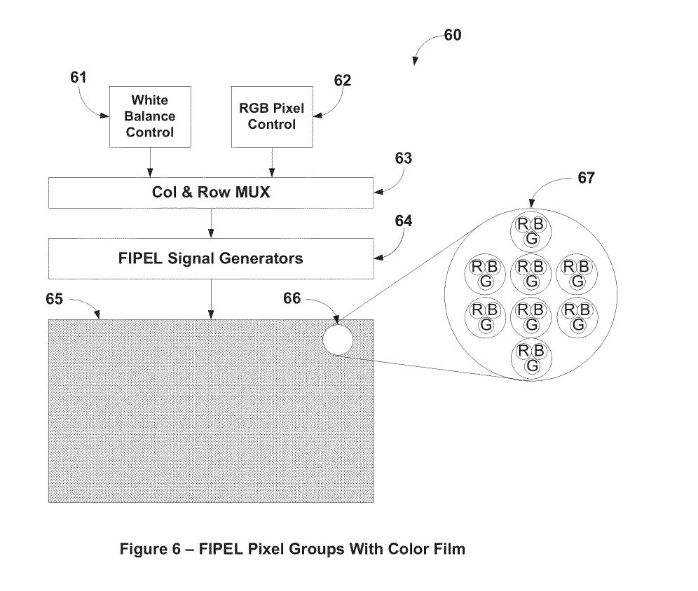

Now referencing FIG. 6 where 60 is a schematic depiction of a FIPEL sub-pixel bidirectional display. In this depiction, FIPEL sub-pixel panel 65 is constructed as an array of small sub-pixel (three sub-pixels per pixel group consisting of RED, BLUE and GREEN sub-pixels) groups. Each pixel is driven to emit or not emit light in the RGB color combination, by appropriate control of the FIPEL signal generators. For a high definition display, the array will contain rows of 1,080 pixel groups and columns of 1,920 pixel groups. This array has an advantage over a similar LCD sub-pixel panel in that it does not contain the pixel driver circuitry consisting of transistors, capacitors and resistors normally found in LCD sub-pixel arrays. In this depiction, 66 depicts a portion of the FIPEL sub-pixel array further magnified and depicted as 67 showing a plurality of sub-pixels where a RED, a BLUE and a GREEN sub-pixel make up a single pixel group where each FIPEL pixel emits light from both the front surface (depicted) and the back surface (not depicted). If the FIPEL sub-pixel array is “turned off” the array will become transparent.

This depiction also shows White Balance Control logic 61 which can shift the color of the white light being emitted through the color filter printed or bonded to the front and back surfaces of each of the sub-pixels. RGB Pixel Control 62 manages which sub-pixel is turned on and off. The White Balance Control logic 61 control signals and the RGB Pixel Control 62 control signals are sent to Col & Row Mux 63 (multiplexor) which in turn sends control signals to FIPEL Signal Generators 64 controlling the frequency of each signal generator, shown in FIGS. 1 through 4 where the frequency assigned to the signal generator determines the exact color sent to each of the sub-pixels. In one embodiment, that color is white-balanced color light.

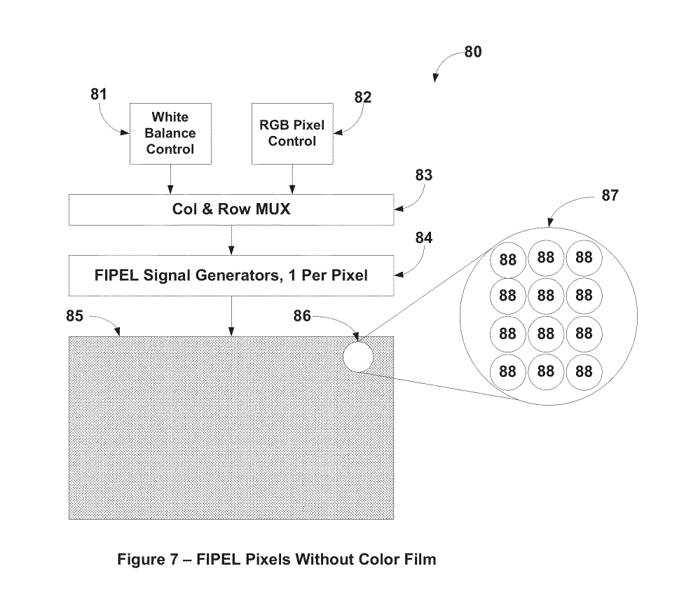

Now referencing FIG. 7 where 80 depicts a FIPEL panel similar to that shown in FIG. 6 except that sub-pixels making up a pixel group are not used. In the present depiction of 80, single pixels are depicted.

In this depiction, FIPEL pixel panel 85 is constructed as an array of single pixels. For a high definition display, the array will contain rows of 1,080 pixels and columns of 1,920 pixels. This array has an advantage over similar LCD sub-pixel panels and the FIPEL sub-pixel panel depicted in FIG. 6. The present depiction does not contain the pixel driver circuitry found in LCD sub-pixel arrays and only contains one third of the (sub) pixels in the depiction shown in FIG. 6. In the present depiction, 86 depicts a portion of the FIPEL pixel array further magnified and depicted as 87 showing a plurality of pixels that can emit light of any color on the CIE color space. Each pixel depicted as 88 in the magnified depiction of 87 emits light from both the front surface (depicted) and the back surface (not depicted). If the FIPEL pixel array is “turned off” the array will become transparent. Visible items can be put underneath to be seen through the array.

This depiction also shows White Balance Control logic 81 which can shift the color of white light being emitted from each pixel in the array. RGB Pixel Control 82 manages which pixel is turned on and off. The White Balance Control logic 81 control signals and the RGB Pixel Control 82 control signals are sent to Col & Row Mux 83 (multiplexor) which in turn sends control signals to FIPEL Signal Generators 84 which in turn control the frequency of each of the signal generators, shown in previous figures where the frequency assigned to the signal generator determines the exact color of the white balanced color sent to each of the pixels.

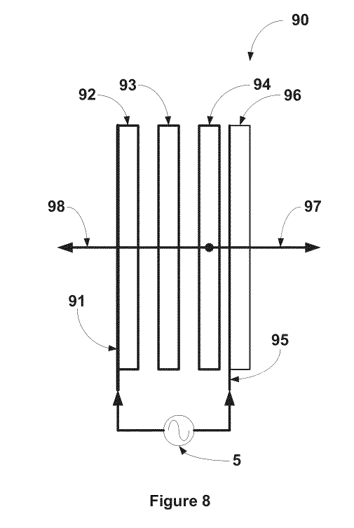

Now referencing FIG. 8 where 90 depicts an exploded side view of a FIPEL panel or pixel that emits light in two directions. In this depiction, transparent field conductor 91 conducts alternating current from signal generator 5 to field substrate 92. Transparent field conductor 91 is bonded to field substrate 92. In this depiction dielectric layer 93 is shown as being physically separated from field substrate 92. Dielectric layer 93 is laid onto field substrate 92. Emissive layer 94 is in direct contact with dielectric layer 93 and in direct physical contact with transparent conductor 95. Transparent conductor 95 conducts alternating current from signal generator 5 to emissive layer 94. Transparent conductor 95 is supported by emissive substrate 96. Transparent conductor 95 carries alternating current from signal generator 5 to emissive layer 94. A specific wavelength of light will be emitted in two directions from emissive layer 94 depending on the frequency of the alternating current being supplied. In this depiction, light 97 is emitted toward the front of the panel/pixel and light 98 is emitted toward the back of the panel/pixel. Note that in actual construction of the FIPEL device there are no gaps or spaces between field substrate 92 and dielectric 93 and no space between dielectric 93 and emissive layer 94 and no space between emissive layer 94 and transparent conductor 95.

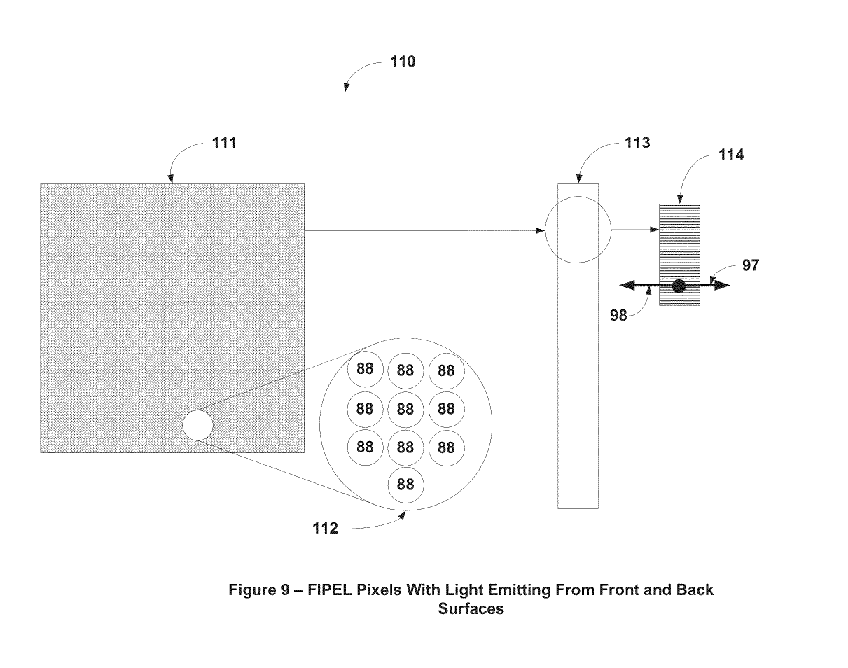

Now referencing FIG. 9 where 110 depicts a front and side view of a pixel based FIPEL array. In this depiction, 111 is a depiction of the front surface of a pixel array FIPEL panel. 112 is a magnified portion of panel 111. Note that 112 shows three columns of pixels 88. 113 depicts a side view of one column of FIPEL pixels. This column would contain 1,920 pixel elements. 113 depicts a magnified portion of pixel column 113. Note that 114 shows a magnified cross section of pixels that appear thick. In actual practice, the thickness of a FIPEL pixel or panel would be more on the order of less than 0.041 thousands of an inch. In this depiction 97 is light emitted toward the front of the pixel and 98 is the light emitted toward the back of the pixel.

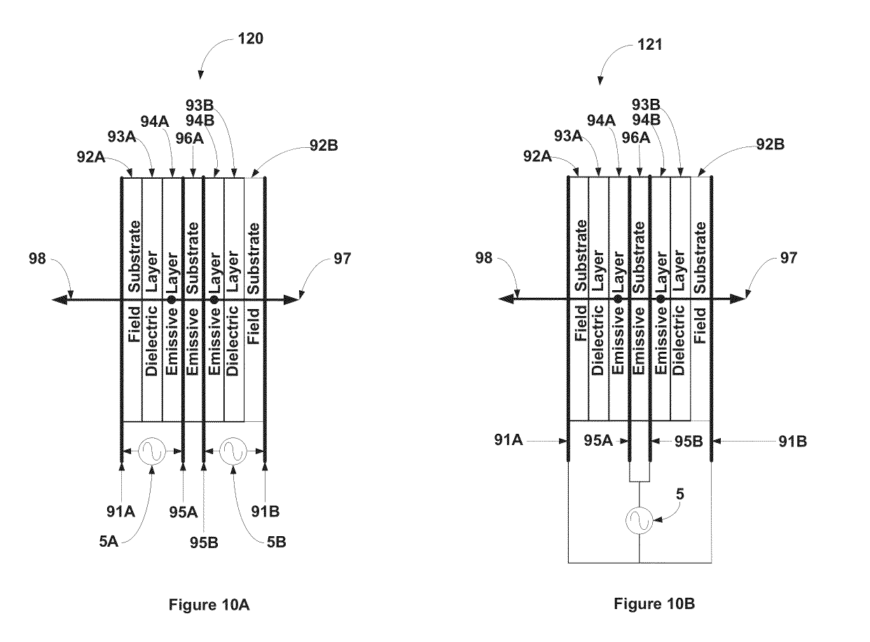

Now referencing FIG. 10A where 120 depicts a side view of a FIPEL pixel where two FIPEL panels are stacked together to increase the amount of light that can be emitted. In this depiction, left side FIPEL panel is comprised of transparent conductive field coating 91A supported by field substrate 92A and conducts alternating current from signal generator 5A, dielectric 93A, emissive layer 94A and transparent conductive emissive coating 95A supported by emissive substrate 96A. The right side FIPEL panel in this depiction is composed of emissive substrate 96A that supports transparent conductive emissive coating 95B, emissive layer 94B, dielectric layer 93B and field substrate 92B supporting transparent conductive field coating 91B. Note that in depiction 120, emissive substrate 96A is common between the left FIPEL panel and the right FIPEL panel. Light from both FIPEL panels emits in two directions from both emissive layers 94A and 94B as emitted light 97 emitting toward the front of the assembly and emitted light 98 emitting toward the back of the assembly.

This depiction allows the color of light from each of the panels to be different based on the fact that each panel has its own signal generator which can emit alternating current at different frequencies. In a slightly different embodiment, a single signal generator as shown in FIG. 10B where 121 depicts this change. The depiction will emit the same frequency of alternating current to each of the emissive layers. Now referencing FIG. 10B, note that transparent conductive emissive coating 95A and 95B are connected together as are transparent conductive field coating 91A and 91B. In this depiction, signal generator 5 provides alternating current to both of the stacked panels and emitted light 97 and 98 will be the same color.

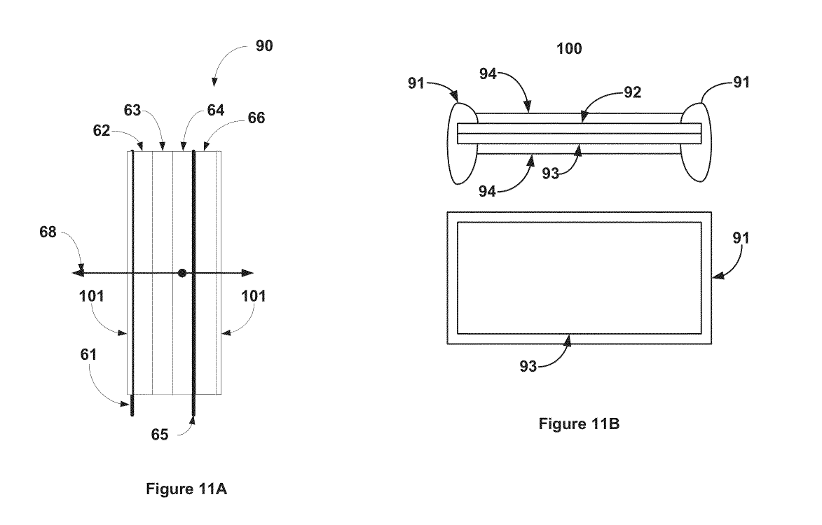

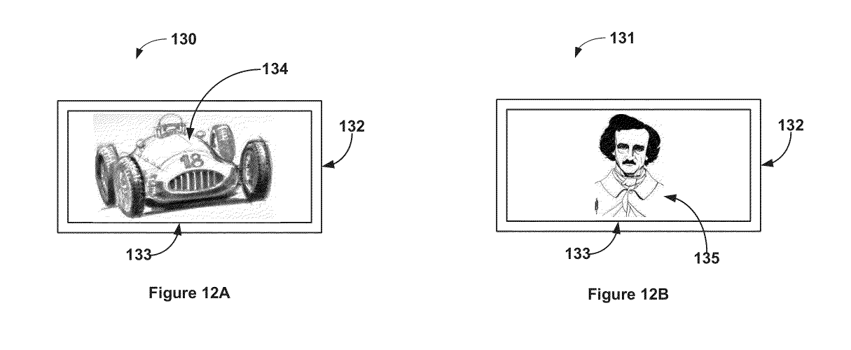

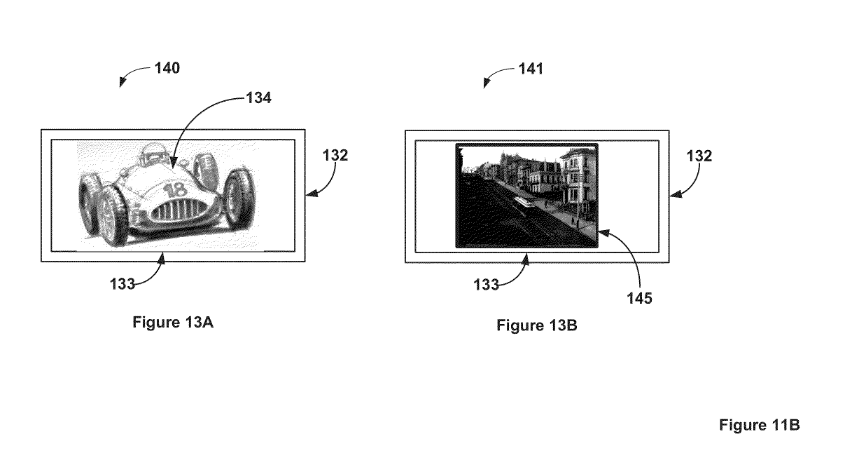

Now referencing FIG. 11A where a FIPEL panel/pixel in an array is depicted. In this depiction structures 101 may be an array of optical microstructures. In one embodiment, the array may be a surface which has one or a plurality of micro-lenses to steer emitted light in a desired direction. This may be for the purpose of creating patterns of light on the surface of a pixel array or for creating some desired effect. The micro-structures may also be diffusors to soften the emitted light. Structures 101 may also be some structure such as SmartGlass™ which can be electrically switch from being transparent to non-transparent and reflective. A SmartGlass™ structure residing behind a FIPEL pixel array can when active provide a reflective surface so that the FIPEL pixel array is only active in a single direction and when the structure is not active the FIPEL pixel array can display images in two directions or be completely transparent.

Now referencing FIG. 11B where a stacked FIPEL panel or pixel arrays are depicted as 92 and 93. In this depiction, 94 is a front and rear housing for a front and rear bezel. In this depiction, structures 91 are light guides that direct or capture some of the light from FIPEL panel/pixel arrays 92 and 93 to the front and rear bezels. Those pixels under the light guide 91 may emit light that is white or any color as set by RPG Pixel Control 82 in FIG. 7. RPG Pixel Control receives data from a microprocessor (not shown) which may vary the intensity and color of light emitted by the pixels under the light guides for front or back lighting of the bezels. These colors and intensity of those pixels may be for the purpose of controlling the contrast between the display screens and the front and back environment. The light can be carried to buttons on the bezel, and/or to at least one actuatable control on the bezel or to illuminate at least one logo on the bezel.

Now referencing FIG. 12A where 130 depicts a television where the active display panel 133, which is a FIPEL display panel, and 132 is the bezel surrounding the FIPEL display panel. In depiction 130, the television is powered on and actively displaying content of a vintage race car 134. In FIG. 12B, depiction 131 is of a television that is turned off or powered off. In this depiction 135 is a portrait of Edgar Allen Poe that is being seen through the television, from, e.g., being on a wall directly behind the television. When the television is not active, the display screen is transparent and the image directly behind the television becomes optically observable.

Now referencing FIG. 13A where 140 depicts the same television as shown in FIG. 12A. Now reference FIG. 13B where depiction 141 is a window in an apartment in San Francisco overlooking a cable car where the window was on a wall directly behind the television. When the television is not active, the display screen is transparent and the scene outside the window directly behind the television becomes optically observable.

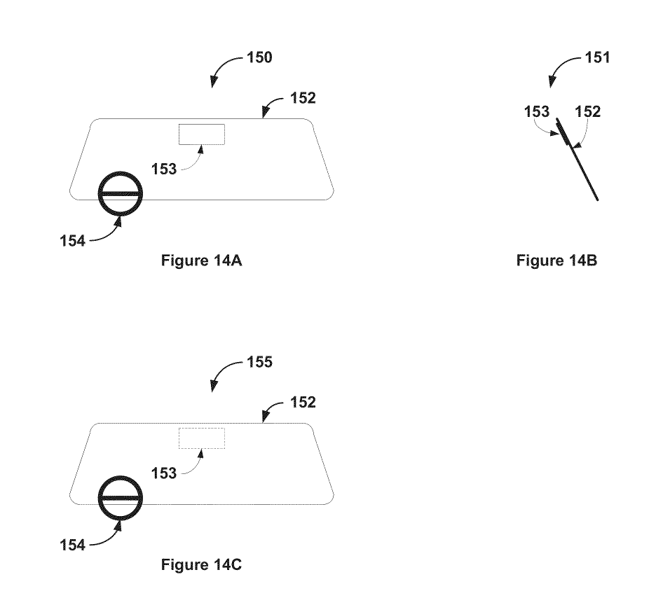

Now referencing FIG. 14A where 150 depicts the windshield of an automobile. In this depiction, windshield 152 contains a review view display that is fixed to the inside of the windshield as shown in an edge view of the windshield in FIG. 14B depiction 151. The driver sits in front of steering wheel 154 and can see display screen 153 to her right. Display screen 153 is driven with moving images captured by a rear facing camera, not shown. If the vehicle is not moving, display screen can be disabled and will become transparent as shown in FIG. 14C. Depiction 155 of FIG. 14C shows the display as transparent with transparency represented as dashed lines for display 153.

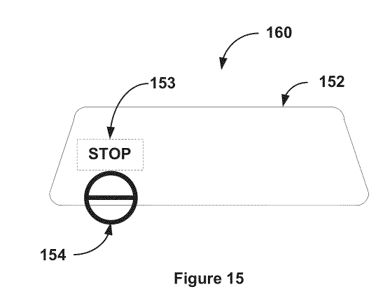

Heads Up displays are well known in the art. These displays typically are constructed using a projector that sits outside of the line of site of the user. The projector will typically project images and text onto either the wind screen of the vehicle the user is driving/piloting or onto a clear panel of glass or plastic that is mounted directly in the line of site of the user's eyes. Now referencing FIG. 15 where the windshield of a vehicle is shown in depiction 160. In this depiction, the drive sits directly in front of steering wheel 154 and display screen 153 is mounted directly to the windshield 152 of the vehicle. In this depiction, the display screen is normally transparent except for messages directed to the drive. In this depiction, display screen 153 is showing a warning message of “STOP” to the driver. In this depiction, some sensor may have detected an eminent danger that is being shown to the user via a head up display directly on the windshield

Although only a few embodiments have been disclosed in detail above, other embodiments are possible and the inventors intend these to be encompassed within this specification. The specification describes certain technological solutions to solve the technical problems that are described expressly and inherently in this application. This disclosure describes embodiments, and the claims are intended to cover any modification or alternative or generalization of these embodiments which might be predictable to a person having ordinary skill in the art. For example, the techniques described herein can be used with other kinds of light modulators and light emitters.

Those of skill would further appreciate that the various illustrative logical blocks, modules, circuits, and algorithm steps described in connection with the embodiments disclosed herein may be implemented as electronic hardware, computer software running on a specific purpose machine that is programmed to carry out the operations described in this application, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments.

The various illustrative logical blocks, modules, and circuits described in connection with the embodiments disclosed herein, may be implemented or performed with a general or specific purpose processor, or with hardware that carries out these functions, e.g., a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has an internal bus connecting to cards or other hardware, running based on a system BIOS or equivalent that contains startup and boot software, system memory which provides temporary storage for an operating system, drivers for the hardware and for application programs, disk interface which provides an interface between internal storage device(s) and the other hardware, an external peripheral controller which interfaces to external devices such as a backup storage device, and a network that connects to a hard wired network cable such as Ethernet or may be a wireless connection such as a RF link running under a wireless protocol such as 802.11. Likewise, external bus 18 may be any of but not limited to hard wired external busses such as IEEE-1394 or USB. The computer system can also have a user interface port that communicates with a user interface, and which receives commands entered by a user, and a video output that produces its output via any kind of video output format, e.g., VGA, DVI, HDMI, displayport, or any other form. This may include laptop or desktop computers, and may also include portable computers, including cell phones, tablets such as the IPAD™ and Android platform tablet, and all other kinds of computers and computing platforms.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, using cloud computing, or in combinations. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium that stores tangible, non transitory computer based instructions. An exemplary storage medium is coupled to the processor such that the processor can read information from, and write information to, the storage medium. In the alternative, the storage medium may be integral to the processor. The processor and the storage medium may reside in reconfigurable logic of any type.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Also, the inventor(s) intend that only those claims which use the words “means for” are intended to be interpreted under 35 USC 112, sixth paragraph. Moreover, no limitations from the specification are intended to be read into any claims, unless those limitations are expressly included in the claims.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A television system, comprising
an emissive layer, formed of first and second conductive and transparent substrates arranged to energize separate pixels on the layer to excite each of plural different pixels separately, and an emissive polymer layer between said first and second conductive and transparent substrates that is energized to emit light through both said first and second conductive and transparent substrates;
a signal generator, that drives the plural different pixels separately, to produce separately controllable output from each of the plural different pixels, said separately controllable output being output through both said first and second conductive and transparent substrates toward a front of the television, and toward a rear of the television; and
a housing that holds said emissive layer, and has a television display portion at a front of the housing and a transparent portion at a rear of said housing through which the controlled pixels emitted by the second conductive and transparent substrates is emitted.

2. The television system as in claim 1, further comprising a video source that drives each of said pixels to create a video image, where said video image is emitted toward both front and back simultaneously.

3. The television system as in claim 1, wherein said transparent portion includes
plural separated optical structures formed thereon.

4. The television system as in claim 3, wherein the optical structures are micro-lenses.

5. The television system as in claim 3, wherein the optical structures are diffuser devices.

6. The television system as in claim 1, wherein the emissive layer is formed of a dielectric layer in addition to said emissive polymer layer, between first and second transparent and conductive substrates.

7. The television system as in claim 6, further comprising a second emissive layer, stacked on said emissive layer, said second emissive layer also including at least one emissive layer, and one dielectric layer, between first and second transparent and conductive substrates.

8. The television system as in claim 7, wherein said first and second emissive layer share one of the transparent and conductive substrates.

9. The television system as in claim 1, further comprising a window that on said housing that electrically switches between transparent and clear.

10. The television system as in claim 9, wherein said window covers said transparent portion.

11. The television system as in claim 1, wherein said housing also includes a bezel at edges of the housing, and said emissive layer illuminates said bezel.

12. The television system as in claim 11, further comprising a light guide that carries light to parts of said bezel.

13. The television system as in claim 12, wherein said light guide carries light to at least one button on said bezel.

14. The television system as in claim 12, wherein said light guide carries light to at least one control on said bezel that can be actuated.

15. The television system as in claim 12, wherein said light guide carries light to at least one logo on said bezel.

16. A television system, comprising
an emissive layer, formed of first and second conductive and transparent substrates arranged to energize separate pixels on the layer to excite each of plural different pixels separately, and an emissive polymer layer between said first and second conductive and transparent substrates that is energized to emit light through both said first and second conductive and transparent substrates; and
a housing that holds said emissive layer, and has a television display portion at a front of the housing and a transparent portion at a rear of said housing through which the pixels emitted by the second conductive and transparent substrates is emitted, said transparent portion having an electrically controllable window that is controlled in a first state to allow emitted light to pass through the window and in a second state to prevent the emitted light from passing through the window.

17. The television system as in claim 16, further comprising a signal generator, that drives the plural different pixels separately, to produce separately controllable output from each of the plural different pixels, said separately controllable output being output through both said first and second conductive and transparent substrates toward a front of the television, and toward the transparent portion.

18. The television system as in claim 17, further comprising a video source that drives each of said pixels to create a video image, where said video image is emitted toward both front and back simultaneously.

19. The television system as in claim 16, wherein said transparent portion includes plural separated optical structures formed thereon.

20. The television system as in claim 19, wherein the optical structures are micro-lenses.

21. The television system as in claim 19, wherein the optical structures are diffuser devices.

22. The television system as in claim 16, wherein the emissive layer is formed of a dielectric layer in addition to said emissive polymer layer, between first and second transparent and conductive substrates.

23. The television system as in claim 22, further comprising a second emissive layer, stacked on said first emissive layer, said second emissive layer also including at least one emissive layer, and one dielectric layer, between first and second transparent and conductive substrates.

24. The television system as in claim 23, wherein said first and second emissive layer share one of the transparent and conductive substrates.

25. The television system as in claim 16, wherein said housing also includes a bezel at edges of the housing, and said emissive layer illuminates said bezel.

26. The television system as in claim 25, further comprising a light guide that carries light to parts of said bezel.

27. The television system as in claim 26, wherein said light guide carries light to at least one button on said bezel.

28. The television system as in claim 26, wherein said light guide carries light to at least one control on said bezel that can be actuated.

29. The television system as in claim 26, wherein said light guide carries light to at least one logo on said bezel.

30. A method of operating a television system, comprising
receiving video information from a video source; and
using said video information to drive each of a plurality of emissive pixels to create a video image that is emitted simultaneously through a front panel of a video display and through a rear panel of the video display.

31. The method as in claim 30, further comprising altering the video image using plural separated optical structures formed on an emitting panel.

32. The method as in claim 31, wherein the optical structures are micro-lenses.

33. The method as in claim 31, wherein the optical structures are diffuser devices.

34. The method as in claim 30, wherein said using comprises using multiple stacked emissive layers to emit pixels of light.
